(19) United States
(12) Patent Application Publication
(10) Pub. No.: US 2008/0187169 A1
(43) Pub. Date: Aug. 7, 2008

(54) IMAGE PROCESSING APPARATUS AND IMAGE PROCESSING METHOD

(75) Inventor: Makoto Harigae, Shinagawa-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/670,688

(22) Filed: Feb. 2, 2007

(51) Int. Cl. G06K 9/00

(52) U.S. Cl. 382/100

(57) ABSTRACT

In an image processing apparatus for performing a specified processing on image data read by an image reading apparatus, there is provided a technique to realize an improvement in efficiency of image processing.

There are included an instruction reception unit to receive an execution instruction of a specified processing on image data read by at least one of plural image reading units to perform image reading at resolutions different from each other, a reading execution unit to cause, based on the instruction received by the instruction reception unit, an image reading processing to be executed by the image reading unit to read the image data as an object of the specified processing and at least one image reading unit other than the image reading unit in the plural image reading units, a processing execution unit to cause, based on the instruction received by the instruction reception unit, the specified processing to be executed on the image data obtained by the image reading processing caused to be executed by the reading execution unit, and a data storage unit to cause post-processing data created by the processing executed by the processing execution unit to correspond to image data read by the image reading unit caused to execute the image reading processing by the reading execution unit and to store them.

### BACKGROUND OF THE INVENTION

1. Field of the Invention

The present invention relates to an image processing apparatus for performing a specified processing on image data read by an image reading apparatus, and particularly to a technique to realize an improvement in efficiency of image processing.

2. Description of the Related Art

FIG. 10 is a view showing a rough structure of an image processing apparatus of the related art. The image processing apparatus (MFP) 9 of the related art shown in the drawing includes a three-line CCD 903 capable of reading an RGB color image. In the image processing apparatus 9 of the related art, the resolution of each of line sensors constituting the three-line CCD 903 is fixed, and in the case where it becomes necessary to provide image data with a low resolution (for example, 300 dpi) based on image data outputted at a high resolution (for example, 600 dpi) from the line sensor, it has been necessary to perform resolution conversion from the high resolution to the low resolution in an image processing unit 904. The same applies to the case where image data with a high resolution is required when the resolution of the line sensor is fixed to a low resolution (for example, 300 dpi).

However, in the case where the resolution conversion is performed in the image processing unit 904 of the image processing apparatus 9 of the related art as described above, there is a case where there occurs such an image deterioration that an image is blurred or an image is distorted. Besides, in the case where the resolution conversion processing is performed in the image processing unit 904, there has been a problem that a memory area for the conversion of the resolution and a time for performing the resolution conversion are required.

Besides, there is also known an image processing apparatus including plural CCD sensors for performing image reading at resolutions different from each other, however, when an image of an original document is read by the image processing apparatus of the structure, only a CCD sensor with one kind of resolution performs image reading in one scan operation. Thus, in the case where an image processing based on image data with a different resolution at which image reading has not been performed is desired to be performed, the image reading operation using the CCD sensor with the resolution must be again performed, and the efficiency has been poor.

### SUMMARY OF THE INVENTION

An embodiment of the invention has an object to provide a technique to realize an improvement in efficiency of image processing in an image processing apparatus for performing a specified processing on image data read by an image reading apparatus.

In order to solve the problem, an image processing apparatus according to an aspect of the invention includes an instruction reception unit configured to receive an execution instruction of a specified processing on image data read by at least one of plural image reading units to perform image reading at resolutions different from each other, a reading execution unit configured to cause, based on the instruction received by the instruction reception unit, an image reading processing to be executed by the image reading unit to read the image data as an object of the specified processing and at least one image reading unit other than the image reading unit in the plural image reading units, a processing execution unit configured to cause, based on the instruction received by the instruction reception unit, the specified processing to be executed on the image data obtained by the image reading processing caused to be executed by the reading execution unit, and data storage unit configured to cause post-processing data created by the processing executed by the processing execution unit to correspond to image data read by the image reading unit caused to execute the image reading processing by the reading execution unit and to store them in a specified storage area.

Besides, an image processing apparatus according to another aspect of the invention includes instruction reception means for receiving an execution instruction of a specified processing on image data read by at least one of plural image reading means for performing image reading at resolutions different from each other, reading execution means for causing, based on the instruction received by the instruction reception means, an image reading processing to be executed by the image reading means that reads the image data as an object of the specified processing and at least one image reading means other than the image reading means in the plural image reading means, processing execution means for causing, based on the instruction received by the instruction reception means, the specified processing to be executed on the image data obtained by the image reading processing caused to be executed by the reading execution means, and data storage means for causing post-processing data created by the processing executed by the processing execution means to correspond to image data read by the image reading means caused to execute the image reading processing by the reading execution means and for storing them in a specified storage area.

Besides, an image processing method according to another aspect of the invention includes the steps of receiving an execution instruction of a specified processing on image data read by at least one of plural image reading units to perform image reading at resolutions different from each other, causing, based on the instruction received at the step of receiving the instruction, an image reading processing to be executed by the image reading unit to read the image data as an object of the specified processing and at least one image reading unit other than the image reading unit in the plural image reading units, causing, based on the instruction received at the step of receiving the instruction, the specified processing to be executed on the image data obtained by the image reading processing caused to be executed by the step of causing the reading processing to be executed, and causing post-processing data created by the processing executed at the step of causing the specified processing to be executed to correspond to the image data read by the image reading unit caused to execute the image reading processing by the step of causing the reading processing to be executed and storing them in a specified storage area.

### DESCRIPTION OF THE DRAWINGS

FIG. 1 is a functional block diagram for explaining an image processing apparatus 1 of an embodiment.

FIG. 2 is a view showing an example of a display screen of a control panel in the image processing apparatus 1 of the embodiment.

FIG. 3 is a view showing an example of a setting item screen in the control panel of the image processing apparatus 1.

FIG. 4 is a view showing an example of setting items on a one-touch button setting screen.

FIG. 5 is a view showing an example of the setting screen in the case where a “color mode” setting key 108a is depressed.

FIG. 6 is a view showing an example of the setting screen in the case where a “resolution” setting key 108b is depressed.

FIG. 7 is a view showing an example of the setting screen in the case where a “storage format” setting key 108c is depressed.

FIG. 8 is a view showing an example of the setting screen in the case where a “storage destination” setting key 108d is depressed.

FIG. 9 is a flowchart for explaining a rough flow of a processing (image processing method) in the image processing apparatus 1 of the embodiment.

FIG. 10 is a view showing a rough structure of an image processing apparatus of the related art.

FIG. 11 is view showing an example of a screen display in a control panel of the image processing apparatus of the related art.

### DESCRIPTION OF THE EMBODIMENTS

Hereinafter, embodiments of the invention will be described with reference to the drawings.

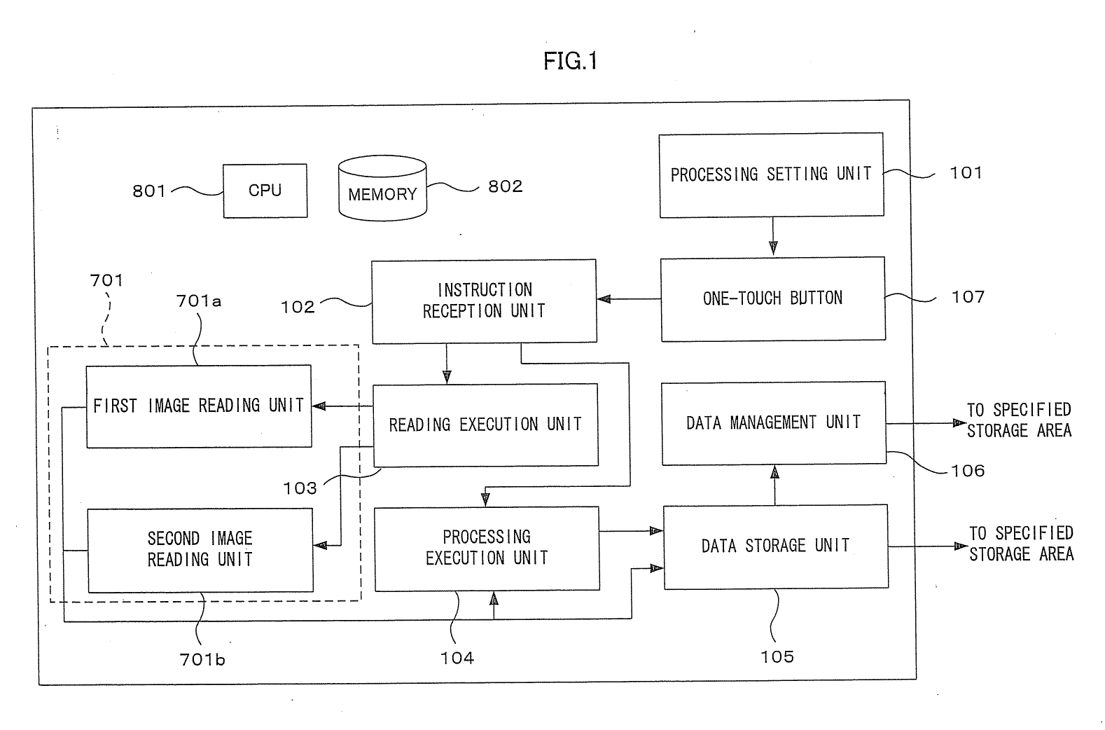

FIG. 1 is a functional block diagram for explaining an image processing apparatus 1 of an embodiment. The image processing apparatus 1 of the embodiment is, for example, an MFP (Multi Function Peripheral).

The image processing apparatus 1 of the embodiment includes plural image reading units 701, a processing setting unit 101, an instruction reception unit 102, a reading execution unit 103, a processing execution unit 104, a data storage unit 105, a data management unit 106, a one-touch button 107, a CPU 801 and a MEMORY 802.

The plural image reading units 701 include plural line sensors to perform image reading at resolutions different from each other. Here, the plural image reading units 701 include a first image reading unit 701a capable of reading a color image, and a second image reading unit 701b capable of reading a monochrome image with a resolution higher than the first image reading unit.

Specifically, the first image reading unit 701a is a line sensor capable of reading an image at a resolution of 300 dpi and in RGB color, and the second image reading unit 701b is a line sensor capable of reading an image at a resolution of 600 dpi and monochromatically.

The one-touch button (specified operation input unit) 107 serves as an interface for instructing, based on operation input of a user, execution of a specified processing on image data read by at least one of the plural image reading units 701.

The processing setting unit 101 sets the content of the specified processing the execution of which is instructed by depression of the one-touch button 107. As stated above, by the depression of the one-touch button 107, the content of the processing made executable can be simply changed as the need arises, so that it becomes possible to perform the image processing with high degree of freedom according to the needs of the user.

Incidentally, as an example of the processing content set by the processing setting unit 101, for example, a past processing having a high use frequency (execution frequency) can be mentioned. Here, the “processing having a high use frequency” is, for example, a data creation processing often used such as a processing of creating document data of a prescribed format specified in an e-document scheme (for example, resolution setting of 300 dpi/600 dpi, color mode setting of monochrome/full color, storage format setting of PDF/TIFF, storage destination setting for storing document data).

The instruction reception unit 102 receives an execution instruction of a specified processing on image data read by at least one (may be a partial image reading unit in the plural image reading units 701 or all the image reading units constituting the plural image reading units 701) of the plural image reading units 701.

The reading execution unit 103 causes, based on the instruction received by the instruction reception unit 102, an image reading processing to be executed by the image reading unit to read the image data as an object of the specified processing and at least one image reading unit other than the image reading unit in the plural image reading units 701. Of course, in the case where image data with a low resolution is required, the image data read by the CCD sensor with the low resolution can be outputted, and in the case where image data with a high resolution is required, the image data read by the CCD sensor with the high resolution can be outputted.

The processing execution unit 104 causes, based on the instruction received by the instruction reception unit 102, the specified processing to be executed on the image data obtained by the image reading processing caused to be executed by the reading execution unit 103.

The data storage unit 105 causes post-processing data created by the processing executed by the processing execution unit 104 to correspond to image data read by the image reading unit caused to execute the image reading processing by the reading execution unit and stores them in a specified storage area (for example, the MEMORY 802).

The data management unit 106 erases, in the data stored in the specified storage area by the data storage unit 105, image data other than the post-processing data after a specified storage period has passed. As stated above, for example, like image data in which six months has passed since the time of the image reading, the data estimated that a possibility of future use is low is sequentially erased, so that a limited storage area can be efficiently used.

The CPU 801 serves to perform various processings in the image processing apparatus 1, and also serves to realize various functions by executing a program stored in the MEMORY 802. The MEMORY 802 includes, for example, a ROM or a RAM, and serves to store various information and programs used in the image processing apparatus 1.

Next, the details of the one-touch button 107 in the image processing apparatus 1 of the embodiment will be described.

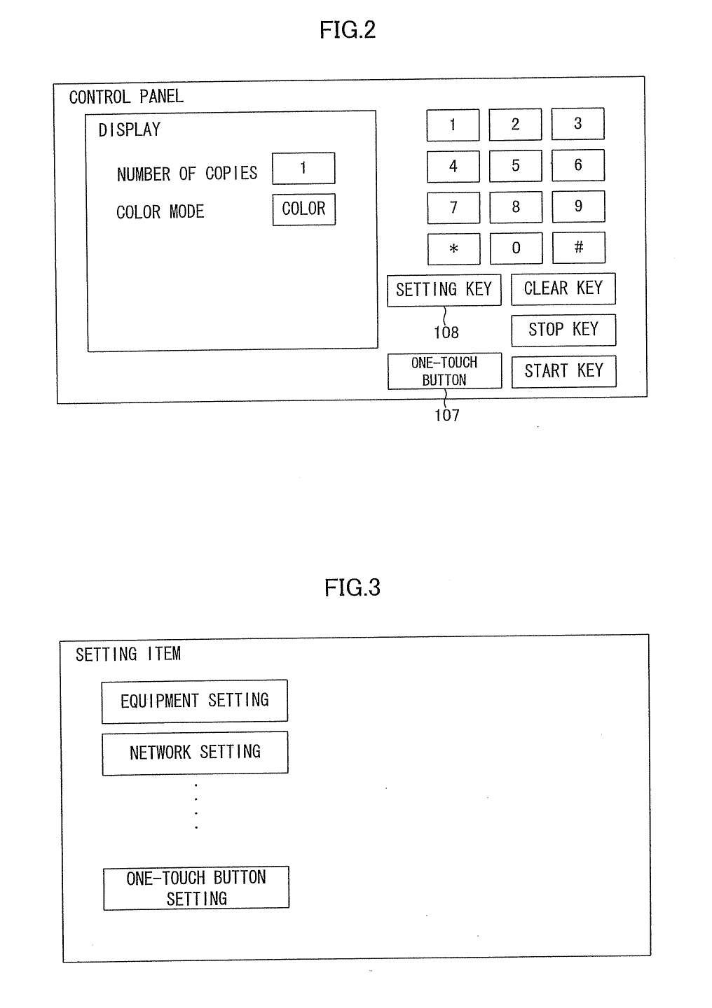

FIG. 2 is a view showing an example of a display screen of a control panel in the image processing apparatus 1 of the embodiment.

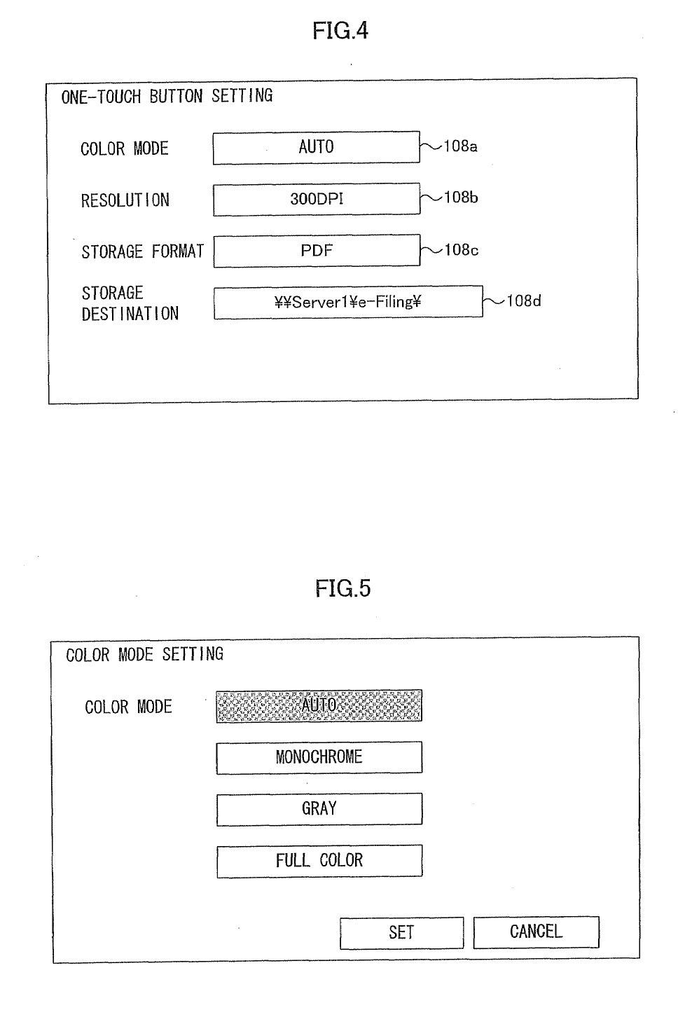

The setting of content of instructions performed by the one-touch button 107 is carried out on a setting item screen which is displayed by depressing a “setting” key 108 shown in FIG. 2. FIG. 3 is a view showing an example of the setting item screen in the control panel of the image processing apparatus 1.

On the setting item screen shown in FIG. 3, when a “one-touch button setting” key is selected, a one-touch button setting screen is displayed. FIG. 4 is a view showing an example of setting items on the one-touch button setting screen.

The items which can be set on the one-touch button setting screen shown in FIG. 4 include a “color mode” setting key 108a to change a color mode such as color reading or monochrome reading, a “resolution” setting key 108b to set resolution at the time of image reading, a “storage format” setting key 108c to set a storage format of image data obtained by image reading, a “storage destination” setting key 108d to set a storage destination of image data obtained by image reading, and the like.

In the case where the setting content in each of the setting items is changed, the “color mode” setting key 108a, the “resolution” setting key 108b, the “storage format” setting key 108c or the “storage destination” setting key 108d is depressed, and desired setting is performed on each of the setting screens.

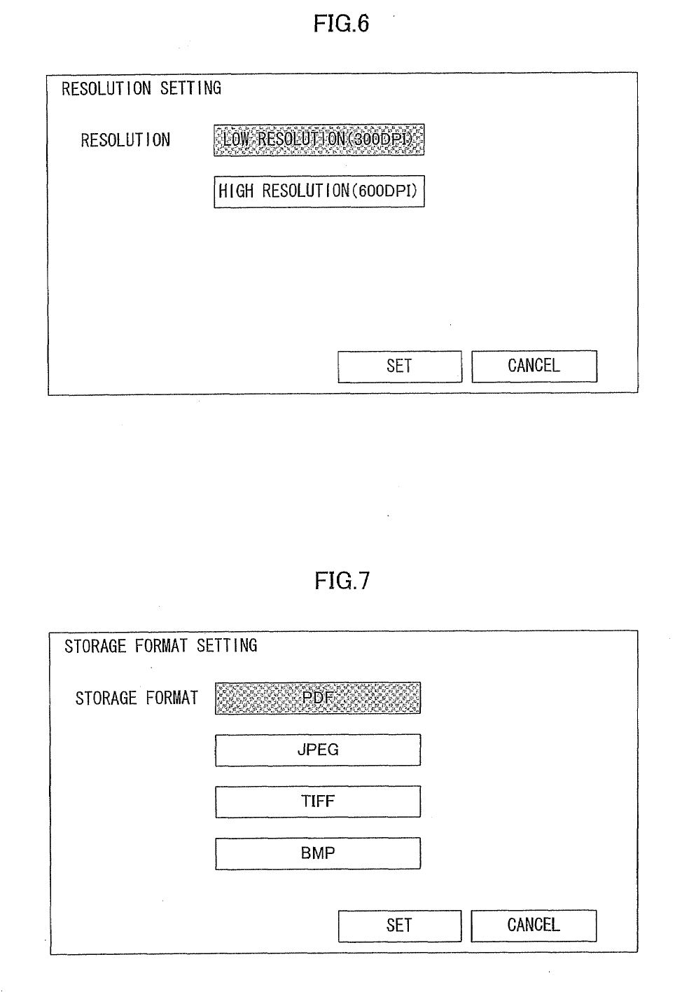

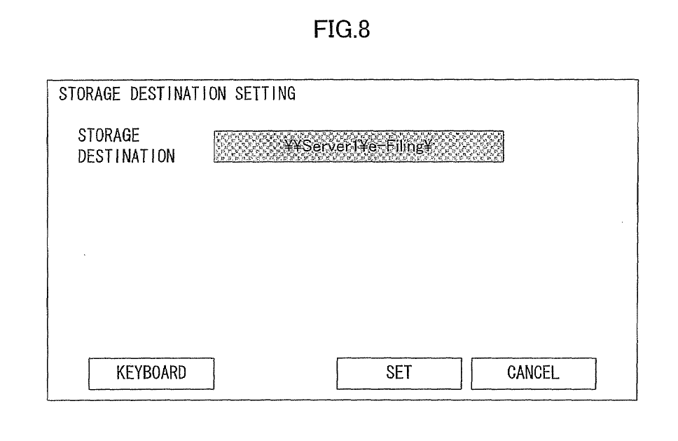

FIG. 5 shows an example of the setting screen in the case where the “color mode” setting key 108a is depressed, FIG. 6 shows an example of the setting screen in the case where the “resolution” setting key 108b is depressed, FIG. 7 shows an example of the setting screen in the case where the “storage format” setting key 108c is depressed, and FIG. 8 shows an example of the setting screen in the case where the “storage destination” setting key 108d is depressed.

In the examples, although the setting examples (FIG. 5 to FIG. 8) of the one-touch button 107 by the operation input of the user to the control panel in the image processing apparatus 1 are shown, no limitation is made to these, and for example, it is also possible to perform the setting through a network from an external equipment connected to be capable of communicating with the image processing apparatus 1. However, it is preferable that the setting of the one-touch button 107 can be set by only a user having the administrator right of e-document.

By adopting the structure of the embodiment as stated above, in the case where image data with a resolution different from the image data obtained by the depression of the one-touch button 107 is required, or in the case where an image processing is desired to be performed on the image data acquired by the depression of the one-touch button 107, image data with a different resolution other than the image data used for the specified processing is stored, so that the image processing having high degree of freedom can be performed by performing the scan operation only once.

Specifically, in the case where it becomes necessary to perform conversion into a resolution other than the resolution of the low resolution or the high resolution, the image data of both the image data with the low resolution and the image data with the high resolution are interpolated, so that it is possible to obtain the image data with a desired resolution (other than the resolution of the image data with the high resolution and the resolution of the image data with the low resolution) in which the blur, distortion and the like of the image are suppressed to the utmost.

Besides, in the case where the color image is read at a high resolution, it is necessary to secure an enormous storage area, however, according to the structure of this embodiment, the resolution of the color image read at the low resolution can be made the high resolution by using the monochrome image data with the high resolution, which has a relatively low data capacity, later as the need arises.

Besides, when the image processing based on the image data read by the image reading unit 701 is performed, it is sufficient if the scan operation is performed only once, and therefore, contribution can be made to elongation of life of consumables such as a driving portion in a scanning optical system.

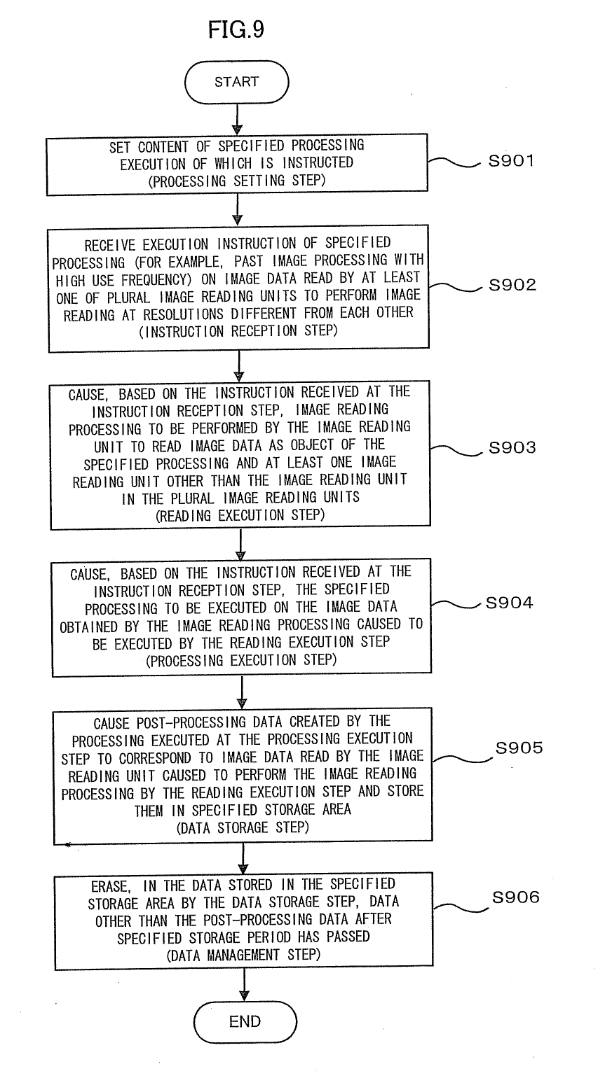

FIG. 9 is a flowchart for explaining a rough flow of the processing (image processing method) in the image processing apparatus 1 of the embodiment.

The processing setting unit 101 sets the content of a specified processing execution of which is instructed (processing setting step) (S901).

The instruction reception unit 102 receives an execution instruction of the specified processing (for example, a past image processing with a high use frequency) on image data read by at least one of the plural image reading units to perform image reading at resolutions different from each other (instruction reception step) (S902).

Based on the instruction received at the instruction reception step, the reading execution unit 103 causes an image reading processing to be executed by the image reading unit to read the image data as an object of the specified processing and at least one image reading unit other than the image reading unit in the plural image reading units (reading execution step) (S903).

Based on the instruction received at the instruction reception step, the processing execution unit 104 causes the specified processing to be executed on the image data obtained by the image reading processing caused to be executed at the reading execution step (processing execution step) (S904).

The data storage unit 105 causes post-processing data created by the processing executed at the processing execution step to correspond to image data read by the image reading unit caused to execute the image reading processing by the reading execution step (data storage step) (S905).

The data management unit 106 erases, in the data stored in the specified storage area by the data storage step, the image data other than the post-processing data after a specified storage period has passed (data management step) (S906).

The respective steps of the processing in the image processing apparatus are realized by causing the CPU 801 to execute an image processing program stored in the MEMORY 802.

In the embodiment, although the description has been made on the case where the function to carry out the invention is previously recorded in the inside of the apparatus, no limitation is made to this, and a similar function may be downloaded from a network to the apparatus, or a similar function recorded on a recording medium may be installed in the apparatus. As the recording medium, any form may be adopted as long as the recording medium, such as a CD-ROM, can store the program and can be read by the apparatus. Besides, the function obtained by the previous installation or download may realize the function in cooperation with an OS (Operating System) of the inside of the apparatus.

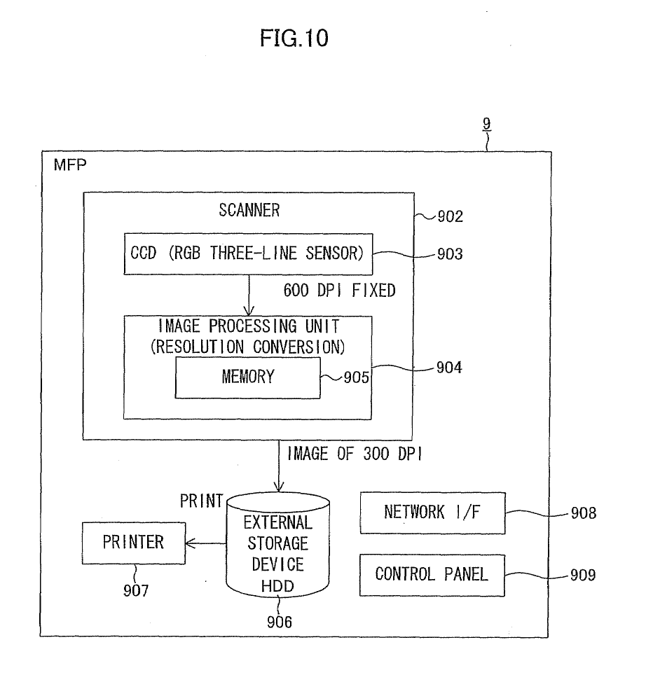

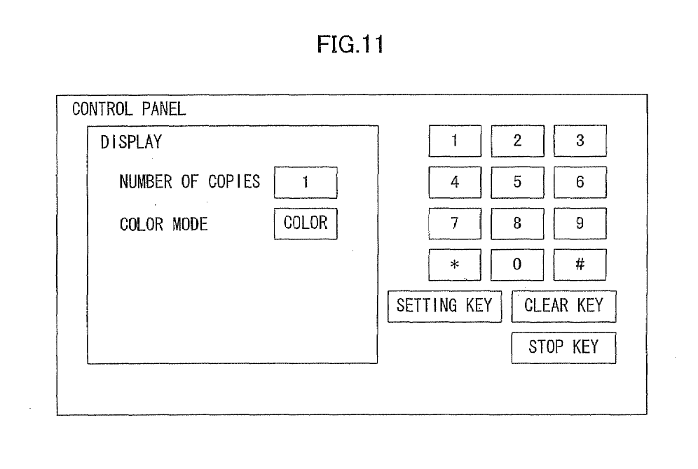

In the image processing apparatus of the related art (see FIG. 10 and FIG. 11), it is necessary to perform the setting as to a way of reading image data, storage format and the like each time the image processing is performed. Besides, also in the case where a template is used, similarly, it is necessary to again set the set value which is set in the template.

On the other hand, according to the embodiment, since the setting of the resolution, processing start and the like is automatically performed by the one-touch button 107, a human mistake such as a setting mistake can be reduced, and the image processing can be executed simply by one-touch. By this, anyone can perform image reading of an original document and the image processing at the same setting.

As described above, according to this embodiment, the image processing setting necessary for the image data obtained by scanning an original document is set in the one-touch button, so that the control panel setting liable to be mistaken can be omitted, and a processing such as resolution conversion can be made not to be performed as much as possible.

Although the invention has been described in detail by use of the specific mode, it would be apparent for one of ordinary skill in the art that various modifications and improvements can be made without departing from the sprit and scope of the invention.

As described above in detail, according to the invention, the technique to realize the improvement in efficiency of the image processing can be provided in the image processing apparatus for performing a specified processing on image data read by the image reading apparatus.

What is claimed is:

1. An image processing apparatus comprising:
an instruction reception unit configured to receive an execution instruction of a specified processing on image data read by at least one of plural image reading units to perform image reading at resolutions different from each other;
a reading execution unit configured to cause, based on the instruction received by the instruction reception unit, an image reading processing to be executed by the image reading unit to read the image data as an object of the specified processing and at least one image reading unit other than the image reading unit in the plural image reading units;
a processing execution unit configured to cause, based on the instruction received by the instruction reception unit, the specified processing to be executed on the image data obtained by the image reading processing caused to be executed by the reading execution unit; and
data storage unit configured to cause post-processing data created by the processing executed by the processing execution unit to correspond to image data read by the image reading unit caused to execute the image reading processing by the reading execution unit and to store them in a specified storage area.

2. The image processing apparatus according to claim 1, wherein the plural image reading units include a first image reading unit capable of reading a color image and a second image reading unit capable of reading a monochrome image with a resolution higher than the first image reading unit.

3. The image processing apparatus according to claim 1, further comprising a specified operation input unit configured to instruct execution of the specified processing on the image data read by at least one of the plural image reading units, wherein
the specified operation input unit instructs execution of a processing with a high use frequency based on an operation input of a user.

4. The image processing apparatus according to claim 1, further comprising a processing setting unit configured to set content of the specified processing the execution of which is instructed by the operation input unit.

5. The image processing apparatus according to claim 1, further comprising a data management unit configured to erase, in the data stored in the specified storage area by the data storage unit, the image data other than the post-processing data after a specified storage period has passed.

6. An image processing apparatus comprising:
instruction reception means for receiving an execution instruction of a specified processing on image data read by at least one of plural image reading means for performing image reading at resolutions different from each other;
reading execution means for causing, based on the instruction received by the instruction reception means, an image reading processing to be executed by the image reading means that reads the image data as an object of the specified processing and at least one image reading means other than the image reading means in the plural image reading means;
processing execution means for causing, based on the instruction received by the instruction reception means, the specified processing to be executed on the image data obtained by the image reading processing caused to be executed by the reading execution means; and
data storage means for causing post-processing data created by the processing executed by the processing execution means to correspond to image data read by the image reading means caused to execute the image reading processing by the reading execution means and for storing them in a specified storage area.

7. The image processing apparatus according to claim 6, wherein the plural image reading means include first image reading means capable of reading a color image and second image reading means capable of reading a monochrome image with a resolution higher than the first image reading means.

8. The image processing apparatus according to claim 6, further comprising specified operation input means for instructing execution of the specified processing on the image data read by at least one of the plural image reading means, wherein
the specified operation input means instructs execution of a processing with a high use frequency based on an operation input of a user.

9. The image processing apparatus according to claim 6, further comprising processing setting means for setting content of the specified processing the execution of which is instructed by the operation input means.

10. The image processing apparatus according to claim 6, further comprising data management means for erasing, in the data stored in the specified storage area by the data storage means, the image data other than the post-processing data after a specified storage period has passed.

11. An image processing method comprising the steps of:
receiving an execution instruction of a specified processing on image data read by at least one of plural image reading units to perform image reading at resolutions different from each other;
causing, based on the instruction received at the step of receiving the instruction, an image reading processing to be executed by the image reading unit to read the image data as an object of the specified processing and at least one image reading unit other than the image reading unit in the plural image reading units;
causing, based on the instruction received at the step of receiving the instruction, the specified processing to be executed on the image data obtained by the image reading processing caused to be executed by the step of causing the reading processing to be executed; and
causing post-processing data created by the processing executed at the step of causing the specified processing to be executed to correspond to the image data read by the image reading unit caused to execute the image reading processing by the step of causing the reading processing to be executed and storing them in a specified storage area.

12. The image processing method according to claim 11, wherein the plural image reading units include a first image reading unit capable of reading a color image and a second image reading unit capable of reading a monochrome image with a resolution higher than the first image reading unit.

13. The image processing method according to claim 11, wherein the specified operation is a past image processing with a high use frequency.

14. The image processing method according to claim 11, further comprising a step of setting content of the specified processing the execution of which is instructed.

15. The image processing method according to claim 11, further comprising a step of erasing, in the data stored in the specified storage area by the step of storing the data, the image data other than the post-processing data after a specified storage period has passed.
